(19) United States
(12) Patent Application Publication
(10) Pub. No.: US 2026/0027652 A1
(43) Pub. Date: Jan. 29, 2026

(54) WELD ASSEMBLY WITH WELD-AID COATING AND PREPARATION METHOD FOR THE WELD ASSEMBLY

(71) Applicant: Yuzhu CUI, Beijing (CN)

(72) Inventors: Yuzhu CUI, Beijing (CN); Xiaoxiao CUI, Beijing (CN); Feng YAN, Beijing (CN); Jing LIU, Beijing (CN)

(73) Assignee: Yuzhu CUI, Beijing (CN)

(21) Appl. No.: 19/349,401

(22) Filed: Oct. 3, 2025

Related U.S. Application Data
(63) Continuation of application No. PCT/CN2023/117827, filed on Sep. 8, 2023.

(30) Foreign Application Priority Data
Apr. 3, 2023 (CN) 202310343041.X

(51) Int. Cl. B23K 26/211; B23K 26/0622; B23K 26/60

(52) U.S. Cl. CPC B23K 26/211; B23K 26/0624; B23K 26/60

(57) ABSTRACT

A weld assembly with a weld-aid coating and preparation method for efficient laser welding of transparent materials. The assembly includes a laser-transparent first welding layer, a second welding layer laminated therewith, and a weld-aid coating at their interface. The coating is strategically applied to the layer with higher multiphoton absorption threshold, or to either layer if thresholds are equal. The preparation method involves applying the weld-aid coating according to comparative multiphoton absorption thresholds, laminating the layers with the coating at their interface, pressing them together, and fixing via ultrashort pulse laser welding. This approach enables optimized laser welding by positioning the weld-aid coating based on material absorption characteristics.

### CROSS-REFERENCE TO RELATED APPLICATIONS

This application is a continuation application of International Application No. PCT/CN2023/117827 filed on Sep. 8, 2023 which claims priority to Chinese Patent Application No. 202310343041.X, filed with the China National Intellectual Property Administration on Apr. 3, 2023, the disclosures of each being incorporated by reference herein in their entireties.

### FIELD

The disclosure relates to a weld assembly with a weld-aid coating and a preparation method for the weld assembly.

### BACKGROUND

Focused ultrashort pulse laser has an ultra-high peak power density, which can induce the nonlinear multiphoton absorption of transparent materials and form high-density plasma spatially and selectively, and then generate a series of influence processes, such as local high-temperature and high-pressure surface ablation, melting, vaporization and condensation, etc. The local fusion of materials may be established at the material interface to achieve welding.

In the related art, the first welding layer is directly welded and fixed to the second welding layer by using a focused ultra-short pulse laser welding method. In this welding structure and method, the welding layer has a high multiphoton absorption threshold, with a large number of photons needed to excite electrons. The non-linear multiphoton absorption efficiency is low. The yield of excited free electrons is low. The duration from a multiphoton absorption state to an avalanche ionization state is low. The laser energy absorption rate is low and the plasma density is low in the same pulse width time domain. Higher peak power densities and high energy inputs are required in practical technical implementations to achieve the focused ultrashort pulse laser welding between the first welding layer and the second welding layer. Due to the large thermal effect, the welded material is easy to produce microcracks, reduce the welding strength and even cause a welding failure. The welding process window is reduced. The welding efficiency is low, and the yield of the product is low.

In the field of laser welding brittle materials, the bonding gap between the materials to be welded is an important factor affecting the welding quality. When the bonding gap between the materials to be welded is larger than the ¼ wavelength of the laser, the welding quality is significantly reduced or even has the welding failure.

### SUMMARY

Provided are a weld assembly with a weld-aid coating and a preparation method therefor, a device, a storage medium, and a program product, which can implement efficient laser welding through strategic weld-aid coating placement based on multiphoton absorption threshold characteristics of welding layers.

According to some embodiments, a weld assembly with a weld-aid coating includes: a first welding layer that is transparent to laser radiation; a second welding layer laminated with the first welding layer; and a weld-aid coating disposed at an interface between the first welding layer and the second welding layer; wherein the weld-aid coating is applied to: the first welding layer, based on the first welding layer having a higher multiphoton absorption threshold than the second welding layer; the second welding layer, based on the second welding layer having a higher multiphoton absorption threshold than the first welding layer; either the first welding layer or the second welding layer based on the first and second welding layer having equal multiphoton absorption threshold; wherein the weld-aid coating is fixed to the first welding layer and the second welding layer by ultrashort pulse laser welding.

According to some embodiments, a preparation method for a weld assembly includes: applying a weld-aid coating to: a first welding layer, based on the first welding layer having a higher multiphoton absorption threshold than a second welding layer; the second welding layer, based on the second welding layer having a higher multiphoton absorption threshold than the first welding layer; or either the first welding layer or the second welding layer based on the first and second welding layers having equal multiphoton absorption thresholds; wherein the first welding layer is transparent to laser radiation; laminating the second welding layer and the first welding layer, wherein the weld-aid coating is located at an interface between the first welding layer and the second welding layer; pressing the second welding layer against the first welding layer to form an assembly to be welded; and welding the assembly to be welded by ultrashort pulse laser welding to fix the weld-aid coating to the first welding layer and the second welding layer.

### BRIEF DESCRIPTION OF THE DRAWINGS

FIG. 1 is an exploded view of a weld assembly according to an embodiment of the present invention.

FIG. 2 is an exploded view of a weld assembly according to another embodiment of the present invention.

FIG. 3 is a schematic view of a preparation method for the weld assembly according to yet another embodiment of the present invention.

### DESCRIPTION OF EMBODIMENTS

The technical solutions in the application will be described clearly and completely in conjunction with the accompanying drawings. Obviously, the described embodiments are part of the embodiments of the application, rather than all of the embodiments. Based on the embodiments in the present application, all other embodiments obtained by a person skilled in the art without involving any inventive effort are within the scope of protection of the present application.

The terms used in the embodiments of the present application are provided for the purpose of describing particular embodiments only and not intended to be limiting of the application. As used in the embodiments of this application and the appended claims, the singular forms “a”, “an”, and “the” are intended to include the plural forms as well, unless the context clearly indicates otherwise.

It should be understood that the term “and/or” used herein, which is just one association relation describing an associated object, means that there can be three kinds of relations. There are three cases, for example, A and/or B can mean A alone, A and B together, and B alone. In addition, the word “I”, as used herein, indicates that the associated object is an “or” relationship.

It should be noted that the terms “upper”, “lower”, “left”, “right”, and the like in the description of the embodiments of the present application are used from the angle shown in the accompanying drawings only and are not to be construed as limiting the embodiments of the present application. In addition, in this context, it should also be understood that when an element is referred to as being connected “on” or “below” another element, it can be directly or indirectly connected “on” or “below” the other element, or it can be indirectly connected “on” or “below” the other element via intervening elements.

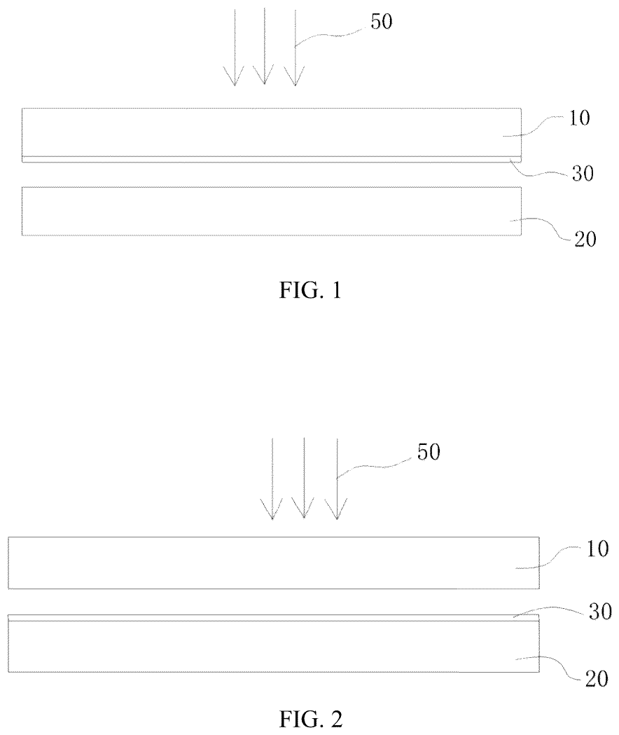

In accordance with a first embodiment of the present invention, a weld assembly with a weld-aid coating is provided. Referring to FIG. 1 or FIG. 2, the weld assembly with the weld-aid coating includes a welding layer and a weld-aid coating 30. The welding layer includes a first welding layer 10 and a second welding layer 20 arranged in a stack.

As shown in FIG. 1, the weld assembly comprises a first welding layer 10, a second welding layer 20, a weld-aid coating 30, and a laser 50.

The first welding layer 10 is a first laser transparent layer. The first laser material may be used for the first laser transparent layer to allow laser light to pass through the first laser transparent layer. For example, the first laser transparent layer 10 may be made of glass, being a first glass layer.

The second welding layer 20 is laminated with the first welding layer 10. The second welding layer 20 is welded and fixed integrally with the first welding layer 10.

The weld-aid coating 30 is disposed at an interface between the first welding layer 10 and the second welding layer 20. There is no weld gap between the first welding layer 10 and the second welding layer 20.

Depending on the magnitude of the multiphoton absorption threshold of the first welding layer 10 and the second welding layer 20, the weld-aid coating 30 may be applied to different welding layers.

The weld-aid coating 30 is applied to one of the first welding layer 10 and the second welding layer 20 having a higher multiphoton absorption threshold, or to either one of the first welding layer 10 and the second welding layer 20 having the same multiphoton absorption threshold. The weld-aid coating 30 is respectively fixed to the first welding layer 10 and the second welding layer 20 by ultrashort pulse laser welding.

In some embodiments, the first welding layer 10 and the second welding layer 20 have different multiphoton absorption thresholds. The weld-aid coating 30 is applied to one of the first welding layer 10 and the second welding layer 20 having a higher multiphoton absorption threshold. For example, as shown in FIG. 1, when the multiphoton absorption threshold of the first welding layer 10 is greater than the multiphoton absorption threshold of the second welding layer 20, the weld-aid coating 30 is applied to the surface of the first welding layer 10. In some embodiments, shown in FIG. 2, when the multiphoton absorption threshold of the first welding layer 10 is less than the multiphoton absorption threshold of the second welding layer 20, the weld-aid coating 30 is applied to the surface of the second welding layer 20.

In some embodiments, when the multiphoton absorption thresholds of the first welding layer 10 and the second welding layer 20 are the same, the weld-aid coating 30 is applied to either one of the first welding layer 10 and the second welding layer 20. For example, as shown in FIG. 1, the weld-aid coating 30 may be applied to the surface of the first welding layer 10. In some embodiments, shown in FIG. 2, the weld-aid coating may be applied to the surface of the second welding layer 20.

By setting the weld-aid coating 30, the weld-aid coating 30 may be set to have a lower multiphoton absorption threshold, which may improve the free electron yield during the multiphoton absorption period in laser welding of the welding assembly, and the time from multiphoton absorption to the realization of avalanche ionization state is shorter, so that “fast ignition” may be realized. There is a longer avalanche ionization time and plasma existence in the same pulse width time domain, the absorption rate of laser energy is higher, and a high-density plasma may be formed. The welding pool between the weld-aid coating 30 and the welding layers 10, 20 is larger in diameter and close to spherical, the welding fusion area is larger, and the shear strength is higher. The weld-aid coating 30 has a high bonding strength with the welding layers 10, 20.

The weld joint formed by the fusion doping of the weld-aid coating 30 and the welding layers 10, 20 has high mechanical strength. The mechanical strength of the weld assembly as a whole is high.

The weld-aid coating 30 may be configured for having a higher optical transmittance, and no nonlinear multiphoton absorption at an optical power of less than 1×10¹¹ W/cm² peak density, so that ambient light received during normal use of the weld assembly does not affect the laser welded structure at the interface between the first welding layer 10 and the second welding layer 20.

The material of weld-aid coating 30 is selected from experiments. Among the intrinsic or doping-based semiconductor materials, some metal oxide intrinsic semiconductors and doping modified semiconductors may achieve high light transmittance, have a forbidden band width far lower than that of SiO₂, and has high mechanical strength after blending with glass or other materials.

In some embodiments, referring to FIG. 1 or FIG. 2, the weld-aid coating 30 may be made from one or more of silicon nitride, tin dioxide doped antimony trioxide, silicon aluminum oxide, titanium oxide, manganese oxide and zinc aluminum oxide.

In some embodiments, the weld-aid coating 30 may be made from tin dioxide doped antimony trioxide (0.5-2 wt %). Herein, the weight proportion of the antimony trioxide in the tin dioxide doped antimony trioxide is 0.5-2%.

In some embodiments, the weld-aid coating 30 may be made from tin dioxide doped antimony trioxide (1.5 wt %). Herein, the weight ratio of the tin dioxide to the antimony trioxide is 98.5:1.5.

In some embodiments, the weight ratio of the tin dioxide to the antimony trioxide in the tin dioxide doped antimony trioxide may also be set to 99.5:0.5, 98:2, or other ratios.

In some embodiments, the weld-aid coating 30 is made from silicon nitride. Herein, the silicon nitride has a molecular cluster number ratio of α phase to β phase of 1:0.2-1:4, or other ratio. The use of silicon nitride for the weld-aid coating 30 has a large plastic deformation and ductility, which may greatly increase the joint area without gap between the weldments.

Using the above-mentioned materials, the weld-aid coating 30 has the characteristics of large plastic deformation and good ductility, so that the gap-free bonding area between weldments is greatly increased, the welding efficiency is higher, and the product yield is higher.

The thickness of the weld-aid coating 30 may be set as desired, taking into account both the light transmission rate and the initial number of excited electrons. In some embodiments, referring to FIG. 1 or FIG. 2, the thickness of the weld-aid coating 30 may be set to 50 nm-2 am. In some embodiments, the thickness of the weld-aid coating 30 may be set to 250 nm.

The manner in which the weld-aid coating 30 is applied to the surface of the welding layer may be configured as desired. In some embodiments, referring to FIG. 1 or FIG. 2, prior to laser welding of the weld assembly, the weld-aid coating 30 may be applied by evaporation or chemical plating or sputtering onto the surface of the welding layer having a higher multiphoton absorption threshold, or onto the surface of any welding layer having the same multiphoton absorption threshold. It is convenient to lay another welding layer on top of the welding layer applied with the weld-aid coating 30 to form the assembly to be welded.

In some embodiments, the weld-aid coating 30 may be magnetron sputtered onto the surface of the welding layer having a higher multiphoton absorption threshold, or onto the surface of any welding layer having the same multiphoton absorption threshold. The background vacuum for magnetron sputtering is less than 5×10⁻⁵ mbar.

The material of the second welding layer 20 may be set as desired. In some embodiments, referring to FIG. 1 or FIG. 2, the second welding layer 20 may be made of a glass material, a ceramic material, a semiconductor material, or a metal material. The second welding layer 20 corresponds to a glass layer, a ceramic layer, a semiconductor layer, or a metal layer.

For example, as shown in FIG. 1 or FIG. 2, the first welding layer 10 may be made of glass, being a first glass layer. The second welding layer 20 may be made of glass, being a second glass layer. Both the first glass layer 10 and the second glass layer 20 are made of a glass material, and the multiphoton absorption thresholds of the two are the same. The weld-aid coating 30 may be applied to the surface of either of the first glass layer 10 and the second glass layer 20. The weld-aid coating 30 is fixed to the first glass layer 10 and the second glass layer 20 on both sides thereof by ultra-short pulse laser welding. The weld assembly is made by the glass-to-glass welding.

In some embodiments, as shown in FIG. 2, the first welding layer 10 may be made from glass, being a first glass layer. The second welding layer 20 may be a ceramic material, being a ceramic layer. The ceramic multiphoton absorption threshold is greater than the glass multiphoton absorption threshold. The weld-aid coating 30 is applied to the surface of the ceramic layer 20. The weld-aid coating 30 is fixed to the first glass layer 10 and the ceramic layer 20 on both sides thereof by the ultra-short pulse laser welding. The weld assembly is made by the glass-ceramic welding.

In some embodiments, as shown in FIG. 1, the first welding layer 10 may be made from glass, being a first glass layer. The second welding layer 20 may be a semiconductor material, being a semiconductor layer. The multiphoton absorption threshold of the first glass layer 10 is greater than the multiphoton absorption threshold of the semiconductor layer 20. The weld-aid coating 30 is applied to the surface of the first glass layer 10. The weld-aid coating 30 is fixed to the first glass layer 10 and the semiconductor layer 20 on both sides thereof by ultrashort pulse laser welding. The weld assembly is made by glass-semiconductor welding.

In some embodiments, as shown in FIG. 1, the first welding layer 10 may be made from glass, being a first glass layer. The second welding layer 20 may be made from a metal, being a metal layer. The multiphoton absorption threshold of the first glass layer 10 is greater than the multiphoton absorption threshold of the metal layer 20. The weld-aid coating 30 is applied to the surface of the first glass layer 10. The weld-aid coating 30 is respectively fixed to the first glass layer 10 and the metal layer 20 on both sides thereof by the ultrashort pulse laser welding. The weld assembly is made by glass-metal welding.

According to the same inventive concept, a second embodiment is also provided. According to the second embodiment, a preparation method for a weld assembly is provided.

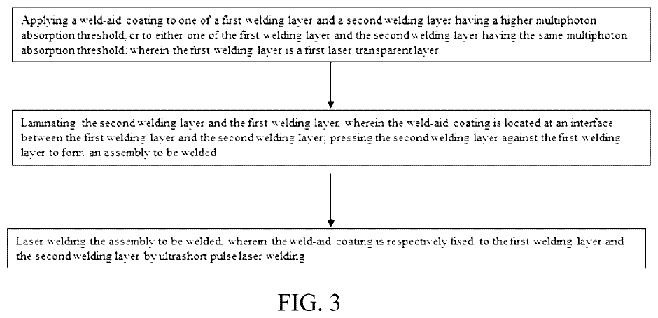

Referring to FIG. 3, the preparation method for the weld assembly includes the following operations.

### Operation 1

Referring to FIG. 1 or FIG. 2, the weld-aid coating 30 is applied to a layer of the first welding layer 10 and the second welding layer 20 having a higher multiphoton absorption threshold, or to either one of the first welding layer 10 and the second welding layer 20 having the same multiphoton absorption threshold. Herein, the first welding layer 10 is a first laser transparent layer.

In this operation, the first welding layer 10 and the second welding layer 20 are welding layers to be welded. The first laser material 10 may be used for the first laser transparent layer to allow laser light to pass through the first laser transparent layer. For example, the first laser transparent layer 10 may be made of glass, being a first glass layer.

Depending on the magnitude of the multiphoton absorption threshold of the first welding layer 10 and the second welding layer 20, the weld-aid coating 30 may be applied to different welding layers. The weld-aid coating 30 is applied to one of the first welding layer 10 and the second welding layer 20 having a higher multiphoton absorption threshold, or to any one of the first welding layer 10 and the second welding layer 20 having the same multiphoton absorption threshold. The weld-aid coating 30 is respectively fixed to the first welding layer 10 and the second welding layer 20 by ultrashort pulse laser welding.

In some embodiments, the first welding layer 10 and the second welding layer 20 have different multiphoton absorption thresholds. The weld-aid coating 30 is applied to one of the first welding layer 10 and the second welding layer 20 having a higher multiphoton absorption threshold. For example, as shown in FIG. 1, when the multiphoton absorption threshold of the first welding layer 10 is greater than the multiphoton absorption threshold of the second welding layer 20, the weld-aid coating 30 is applied to the surface of the first welding layer 10. In some embodiments, shown in FIG. 2, when the multiphoton absorption threshold of the first welding layer 10 is less than the multiphoton absorption threshold of the second welding layer 20, the weld-aid coating 30 is applied to the surface of the second welding layer 20.

In another alternative, when the multiphoton absorption thresholds of the first welding layer 10 and the second welding layer 20 are the same, the weld-aid coating 30 is applied to either one of the first welding layer 10 and the second welding layer 20. For example, as shown in FIG. 1, the weld-aid coating 30 may be applied to the surface of the first welding layer 10. In some embodiments, shown in FIG. 2, the weld-aid coating may be applied to the surface of the second welding layer 20.

The weld-aid coating 30 may be set to have a lower multiphoton absorption threshold, which may improve the free electron yield during the multiphoton absorption period in laser welding of the welding assembly, and the time from multiphoton absorption to the realization of avalanche ionization state is shorter, so that “fast ignition” may be realized. There is a longer avalanche ionization time and plasma existence in the same pulse width time domain, the absorption rate of laser energy is higher, and a high-density plasma may be formed.

The weld-aid coating 30 may be configured for having a higher optical transmittance, and no nonlinear multiphoton absorption at an optical power of less than 1×10¹¹ W/cm² peak density.

The material of the second welding layer 20 may be set as desired. In some embodiments, referring to FIG. 1 and FIG. 2, the second welding layer 20 may be made of a glass material, a ceramic material, a semiconductor material, or a metal material. The second welding layer 20 corresponds to a glass layer, a ceramic layer, a semiconductor layer, or a metal layer.

For example, as shown in FIG. 1 or FIG. 2, the first welding layer 10 may be made of glass, being a first glass layer. The second welding layer 20 may be made of glass, being a second glass layer. Both the first glass layer 10 and the second glass layer 20 are made of a glass material, and the multiphoton absorption thresholds of the two are the same. The weld-aid coating 30 may be applied to the surface of either of the first glass layer 10 and the second glass layer 20.

In some embodiments, as shown in FIG. 2, the first welding layer 10 may be made from glass, being a first glass layer. The second welding layer 20 may be a ceramic material, being a ceramic layer. The ceramic multiphoton absorption threshold is greater than the glass multiphoton absorption threshold. The weld-aid coating 30 is applied to the surface of the ceramic layer 20.

In some embodiments, as shown in FIG. 1, the first welding layer 10 may be made from glass, being a first glass layer. The second welding layer 20 may be a semiconductor material, being a semiconductor layer. The multiphoton absorption threshold of the first glass layer 10 is greater than the multiphoton absorption threshold of the semiconductor layer 20. The weld-aid coating 30 is applied on the surface of the first glass layer 10.

In some embodiments, as shown in FIG. 1, the first welding layer 10 may be made from glass, being a first glass layer. The second welding layer 20 may be made from a metal, being a metal layer. The multiphoton absorption threshold of the first glass layer 10 is greater than the multiphoton absorption threshold of the metal layer 20. The weld-aid coating 30 is applied to the surface of the first glass layer 10. The weld-aid coating 30 is applied to the surface of the metal layer 20. The material of weld-aid coating 30 is selected from experiments. Among the intrinsic or doping-based semiconductor materials, some metal oxide intrinsic semiconductors and doping modified semiconductors may achieve high light transmittance, have a forbidden band width far lower than that of SiO2, and has high mechanical strength after blending with the welding layers 10 and 20 made from glass or other materials.

Alternatively, referring to FIG. 1 or FIG. 2, the weld-aid coating 30 may be made from one or more of silicon nitride, tin dioxide doped antimony trioxide, silicon aluminum oxide, titanium oxide, manganese oxide and zinc aluminum oxide.

In some embodiments, the weld-aid coating 30 may be made from tin dioxide doped antimony trioxide (0.5-2 wt %). Herein, the weight proportion of the antimony trioxide in the tin dioxide doped antimony trioxide is 0.5-2%.

Further, the weld-aid coating 30 may be made from tin dioxide doped antimony trioxide (1.5 wt %). Herein, the weight ratio of the tin dioxide to the antimony trioxide is 98.5:1.5.

Of course, in other embodiments, the weight ratio of the tin dioxide to the antimony trioxide in the tin dioxide doped antimony trioxide may also be set to 99.5:0.5, 98:2, or other ratios.

In some embodiments, the weld-aid coating 30 is made from silicon nitride. Herein, the silicon nitride has a molecular cluster number ratio of α phase to β phase is 1:0.2 to 1:4, or other ratio. The use of silicon nitride for the weld-aid coating 30 has a large plastic deformation and ductility, which may greatly increase the joint area without gap between the weldments.

The thickness of the weld-aid coating 30 may be set as desired, taking into account both the light transmission rate and the initial number of excited electrons. In some embodiments, referring to FIG. 1 and FIG. 2, the thickness of the weld-aid coating 30 may be set to 50 nm-2 μm. The thickness of the weld-aid coating 30 may be set to 250 nm.

The manner in which the weld-aid coating 30 is applied to the surface of the welding layer may be configured as desired. In some embodiments, referring to FIG. 1 or FIG. 2, prior to laser welding of the weld assembly, the weld-aid coating 30 may be applied by evaporation or chemical plating or sputtering onto the surface of the welding layer having a higher multiphoton absorption threshold, or onto the surface of any welding layer having the same multiphoton absorption threshold. In this manner, it is convenient to lay another welding layer on top of the welding layer applied with the weld-aid coating 30 to form the assembly to be welded.

The weld-aid coating 30 may be magnetron sputtered onto the surface of the welding layer having a higher multiphoton absorption threshold, or onto the surface of any welding layer having the same multiphoton absorption threshold. The background vacuum for magnetron sputtering is less than 5×10^{0.5} mbar.

### Operation 2

Referring to FIG. 1 or FIG. 2, the second welding layer 20 is stacked with the first welding layer 10 with the weld-aid coating 30 at an interface between the first welding layer 10 and the second welding layer 20. The second welding layer 20 is pressed against the first welding layer 10 to form the assembly to be welded.

In this operation, the second welding layer 20 and the first welding layer 10 are stacked on a welding device with the weld-aid coating 30 at the interface between the first welding layer 10 and the second welding layer 20. The welding device presses the second welding layer 20 against the first welding layer 10 to form the assembly to be welded. There is no weld gap between the first welding layer 10 and the second welding layer 20.

The welding device may be embodied as a welding station that mechanically presses the second welding layer 20 against the first welding layer 10. The welding device may press the second welding layer 20 and the first welding layer 10, which are stacked, from both sides in the thickness direction, respectively. There is no welding gap between the first welding layer 10 and the second welding layer 20, so as to facilitate subsequent laser welding thereof. The construction of the welding device may be prior art and will not be described in detail herein.

### Operation 3

Referring to FIG. 1 or FIG. 2, the assembly to be welded is welded by ultrashort pulse laser welding such that the weld-aid coating 30 is focused on ultrashort pulse laser welding with the first welding layer 10 and the second welding layer 20, respectively, thereby forming the weld assembly in the first embodiment.

In this operation, since the first welding layer 19 is a first laser transparent layer, laser 50 may enter the assembly to be welded from a side of the first welding layer 10 facing away from the second welding layer 20, thereby ultra-short pulse laser welding the assembly to be welded.

Since the weld-aid coating 30 may be set to have a lower multiphoton absorption threshold, which may improve the free electron yield during the multiphoton absorption period in laser welding of the welding assembly, and the time from multiphoton absorption to the realization of avalanche ionization state is shorter, so that “fast ignition” may be realized. There is a longer avalanche ionization time and plasma existence in the same pulse width time domain, the absorption rate of laser energy is higher, and a high-density plasma may be formed. Thus, the welding pool between the weld-aid coating 30 and the welding layers 10, 20 is larger in diameter and close to spherical, the welding fusion area is larger, and the shear strength is higher. The weld-aid coating 30 has a high bonding strength with the welding layers 10, 20. By setting the weld-aid coating 30, the weld-aid coating 30 has the characteristics of large plastic deformation and good ductility, so that the gap-free bonding area between weldments is greatly increased, the welding efficiency is higher, and the product yield is higher.

The weld joint formed by the fusion doping of the weld-aid coating 30 and the welding layers 10, 20 has high mechanical strength. The mechanical strength of the weld assembly as a whole is high.

Since the weld-aid coating 30 may be configured for having a higher optical transmittance, and no nonlinear multiphoton absorption at an optical power of less than 1×10¹¹ W/cm² peak density, ambient light received during After normal use of the weld assembly does not affect the laser welded structure at the interface between the first welding layer 10 and the second welding layer 20.

As described above, the materials of the first welding layer 10 and the second welding layer 20 may be set as needed.

For example, as shown in FIG. 1 or FIG. 2, the first welding layer 10 may be made from glass, being a first glass layer. The second welding layer 20 may be made of glass, being a second glass layer. The first glass layer 10 and the second glass layer 20 are both made from a glass material, and the multiphoton absorption thresholds of the two are the same. The weld-aid coating 30 may be applied to the surface of either one of the first glass layer 10 and the second glass layer 20. The weld-aid coating 30 in this operation is respectively fixed to the first glass layer 10 and the second glass layer 20 on both sides thereof by ultrashort pulse laser welding. The weld assembly is made by glass-glass welding.

For example, as shown in FIG. 2, the first welding layer 10 may be made from glass, being a first glass layer. The second welding layer 20 may be made from ceramic, being a ceramic layer. The ceramic multiphoton absorption threshold is greater than the glass multiphoton absorption threshold. The weld-aid coating 30 is applied to the surface of the ceramic layer 20. The weld-aid coating 30 in this operation is respectively fixed to the first glass layer 10 and the ceramic layer 20 on both sides thereof by ultrashort pulse laser welding. The weld assembly is made by the glass-ceramic welding.

In some embodiments, as shown in FIG. 1, the first welding layer 10 may be made from glass, being a first glass layer. The second welding layer 20 may be a semiconductor material, being a semiconductor layer. The multiphoton absorption threshold of the first glass layer 10 is greater than the multiphoton absorption threshold of the semiconductor layer 20. The weld-aid coating 30 is applied on the surface of the first glass layer 10. The weld-aid coating layer 30 in this operation is respectively fixed to the first glass layer 10 and the semiconductor layer 20 on both sides thereof by ultrashort pulse laser welding. The weld assembly is made by glass-semiconductor welding.

For example, as shown in FIG. 1, the first welding layer 10 may be made from glass, being a first glass layer. The second welding layer 20 may be made from metal, being a metal layer. The multiphoton absorption threshold of the first glass layer 10 is greater than the multiphoton absorption threshold of the metal layer 20. The weld-aid coating 30 is applied to the surface of the first glass layer 10. The weld-aid coating 30 in this operation is respectively fixed to the first glass layer 10 and the metal layer 20 on both sides thereof by the ultrashort pulse laser welding. The weld assembly is made by glass-metal welding.

In an embodiment, referring to FIG. 1 or FIG. 2, the first welding layer 10 is a first glass layer. The second welding layer 20 is a second glass layer. The weld-aid coating 30 is made from silicon nitride, and the silicon nitride has a molecular cluster number ratio of an α phase to β phase of 1:1. The thickness of the weld-aid coating 30 is set to 250 nm. The weld-aid coating 30 is applied to the surface of the first welding layer 10 by magnetron sputtering with a background vacuum of less than 5×10⁻⁵ mbar.

Compared with the prior art without the weld-aid coating, the vertical offset error control at the focal point interface may be increased from ±10 μm to ±30 μm, the weld width may be increased from 40 μm to 110 μm, and the shear force that the weld may withstand may be increased from 10.840 μm to 15.7 MP at the same power of 10 W by using the above preparation method for the weld assembly. See Table 1.

TABLE 1

| Weld | | Allowable vertical offset | Weld | Shear force |
|---|---|---|---|---|
| assembly | Power | error value at a focus | width | MP |
| No weld-aid | lOw | +I 0 ttm | 40 μm | 10.8 |
| coating | | | | |
| With weld- | 10 w | t30 μm | 110 μm | 15.7 |
| aid coating | | | | |

In the present invention, the weld-aid coating is applied to one of the first welding layer and the second welding layer having a higher multiphoton absorption threshold, or to either one of the first welding layer and the second welding layer having the same multiphoton absorption threshold. The weld-aid coating is respectively fixed to the first welding layer and the second welding layer by ultrashort pulse laser welding. The weld fusion area between the weld-aid coating and the welding layer is larger and the shear strength is high. The weld-aid coating has a high bond strength with the welding layer. The weld joint formed by the fusion doping of weld-aid coating and welding layer has higher mechanical strength. The overall strength of weld assembly is higher. By setting the weld-aid coating, the weld-aid coating has the characteristics of large plastic deformation and good ductility, so that the gap-free bonding area between weldments is greatly increased, the welding efficiency is higher, and the product yield is higher.

The foregoing is embodiments of the present invention and is not intended to limit the scope of the invention. It is intended that the invention be construed as including all such modifications, equivalent substitutions and alterations insofar as they come within the scope of the appended claims or the equivalents thereof.

What is claimed is:

1. A weld assembly with a weld-aid coating, comprising:
a first welding layer that is transparent to laser radiation;
a second welding layer laminated with the first welding layer; and
a weld-aid coating disposed at an interface between the first welding layer and the second welding layer;
wherein the weld-aid coating is applied to:
the first welding layer, based on the first welding layer having a higher multiphoton absorption threshold than the second welding layer;
the second welding layer, based on the second welding layer having a higher multiphoton absorption threshold than the first welding layer;
either the first welding layer or the second welding layer based on the first and second welding layer having equal multiphoton absorption threshold;
wherein the weld-aid coating is fixed to the first welding layer and the second welding layer by ultrashort pulse laser welding.

2. The weld assembly with the weld-aid coating according to claim 1,
wherein the weld-aid coating comprises at least one material selected from a group including: silicon nitride, tin dioxide doped antimony trioxide, silicon aluminum oxide, titanium oxide, manganese oxide, or zinc aluminum oxide;
wherein in case that the weld-aid coating comprises tin dioxide doped antimony trioxide, the weight proportion of the antimony trioxide in the tin dioxide doped antimony trioxide is 0.5-2%;
wherein in a case that the weld-aid coating comprises silicon nitride, the silicon nitride has a molecular cluster number ratio of α phase to β phase of 1:0.2 to 1:4.

3. The weld assembly with the weld-aid coating according to claim 1,
wherein the weld-aid coating comprises:
tin dioxide doped antimony trioxide that has ratio of the tin dioxide to the antimony trioxide is 98.5:1.5; or,
silicon nitride that has a molecular cluster number ratio of an α phase to β phase of 1:0.2 to 1:4.

4. The weld assembly with the weld-aid coating according to claim 1, wherein the weld-aid coating has a thickness of 50 nm to 2 μm.

5. The weld assembly with the weld-aid coating according to claim 1, wherein the second welding layer comprises a material selected from a group including: glass, ceramic, semiconductor, or metal.

6. A preparation method for a weld assembly, characterized by comprising:
applying a weld-aid coating to:
a first welding layer, based on the first welding layer having a higher multiphoton absorption threshold than a second welding layer;
the second welding layer, based on the second welding layer having a higher multiphoton absorption threshold than the first welding layer; or
either the first welding layer or the second welding layer based on the first and second welding layers having equal multiphoton absorption thresholds;
wherein the first welding layer is transparent to laser radiation;
laminating the second welding layer and the first welding layer,
wherein the weld-aid coating is located at an interface between the first welding layer and the second welding layer;
pressing the second welding layer against the first welding layer to form an assembly to be welded; and
welding the assembly to be welded by ultrashort pulse laser welding to fix the weld-aid coating to the first welding layer and the second welding layer.

7. The preparation method for the weld assembly according to claim 6, wherein the applying comprises:
applying the weld-aid coating on a surface of the first welding layer or the second welding layer by magnetron sputtering with a background vacuum of less than 5×10⁻⁵ mbar; or
applying the weld-aid coating on a surface of the first welding layer or the second welding layer by evaporation or chemical plating.

8. The preparation method for the weld assembly according to claim 6,
wherein the weld-aid coating comprises at least one material selected from a group including: silicon nitride, tin dioxide doped antimony trioxide, silicon aluminum oxide, titanium oxide, manganese oxide, or zinc aluminum oxide;
wherein in case that the weld-aid coating comprises tin dioxide doped antimony trioxide, the weight proportion of the antimony trioxide in the tin dioxide doped antimony trioxide is 0.5 to 2%;
wherein in case that the weld-aid coating comprises silicon nitride, the silicon nitride has a molecular cluster number ratio of α phase to β phase of 1:0.2 to 1:4.

9. The preparation method for the weld assembly according to claim 6, wherein the weld-aid coating comprises:
tin dioxide doped antimony trioxide that has a weight ratio of the tin dioxide to the antimony trioxide is 98.5:1.5, wherein the tin dioxide doped antimony trioxide has a thickness of 50 nm-2 μm; or,
silicon nitride that has a molecular cluster number ratio of an α phase to β phase of 1:0.2 to 1:4, and wherein the silicon nitride has a thickness of 50 nm to 2 μm.

10. The preparation method for the weld assembly according to claim 6, wherein the second welding layer comprises a material selected from a group including: glass, ceramic, semiconductor, or metal.
